(19) United States
(12) Patent Application Publication
(10) Pub. No.: US 2023/0196586 A1
(43) Pub. Date: Jun. 22, 2023

(54) VIDEO PERSONNEL RE-IDENTIFICATION METHOD BASED ON TRAJECTORY FUSION IN COMPLEX UNDERGROUND SPACE

(71) Applicant: China University of Mining and Technology, Xuzhou (CN)

(72) Inventors: Yanjing SUN, Xuzhou (CN); Xiao YUN, Xuzhou (CN); Kaiwen DONG, Xuzhou (CN); Kaili SONG, Xuzhou (CN); Xiaozhou CHENG, Xuzhou (CN)

(21) Appl. No.: 18/112,725

(22) Filed: Feb. 22, 2023

Related U.S. Application Data
(63) Continuation of application No. PCT/CN2022/105043, filed on Jul. 12, 2022.

(30) Foreign Application Priority Data
Nov. 10, 2021 (CN) 202111328521.6

(51) Int. Cl. G06T 7/20; G06V 10/26; G06V 10/44; G06V 10/62; G06V 10/74; G06V 10/80; G06F 16/738

(52) U.S. Cl. CPC G06T 7/20; G06V 10/26; G06V 10/44; G06V 10/62; G06V 10/761; G06V 10/806; G06F 16/738; G06T 2207/30241

(57) ABSTRACT

Disclosed is a video personnel re-identification method based on trajectory fusion in a complex underground space; an accurate personnel trajectory prediction may be realized through the Social-GAN model; and a spatio-temporal trajectory fusion model is constructed, and personnel trajectory videos that are not affected by the occlusion are introduced into the re-identification network to solve the problem of false extraction of the apparent visual features caused by the occlusion. In addition, a trajectory fusion MARS_traj data set is constructed, and a number of time frames and space coordinate information are added to the MARS data set.

### CROSS-REFERENCE TO RELATED APPLICATIONS

This application is a continuation of international application No. PCT/CN2022/105043, filed on Jul. 12, 2022 and claims priority to Chinese Patent Application No. 202111328521.6, filed on Nov. 10, 2021, the contents of which are hereby incorporated by reference.

### TECHNICAL FIELD

The application belongs to the field of image processing, and in particular relates to a video personnel re-identification method based on trajectory fusion in a complex underground space.

### BACKGROUND

Personnel re-identification refers to retrieval of personnel with a same identity from personnel images taken across cameras. The personnel re-identification may be divided into image personnel re-identification and video personnel re-identification according to a difference of input data. Compared with the image personnel re-identification, the video personnel re-identification includes more information, including time information and motion information between frames. With a development of video surveillance equipment, more attention has been paid to the video personnel re-identification using time information clues.

In recent years, a great progress has been made in a research of the video personnel re-identification. However, the video personnel re-identification in a complex underground space and other places still faces many challenges. For example, due to problems such as insufficient and uneven lighting and target occlusion caused by crowded scenes, an appearance of the personnel may change dramatically. Therefore, the target occlusion is one of the biggest difficulties of the video personnel re-identification in the complex underground space.

Commonly used methods to solve the problem of target occlusion are attention mechanisms and generative adversarial networks. The attention mechanisms, such as quality aware network (QAN) proposed by Liu et al. and attentive spatio-temporal pooling networks (ASTPN) proposed by Xu et al., use attention models to select discriminative frames from video sequences to generate informative video representations, but may discard partially occluded images. Therefore, some scholars have proposed to use the generative adversarial networks, such as spatio-temporal completion network (STCNet) proposed by Hou et al., to reproduce appearance representations of occluded parts. However, the generative adversarial networks may only restore an appearance of the image that is partially occluded, while the appearance of the image that is occluded in a large area is difficult to be restored.

### SUMMARY

According to the application, a trajectory prediction Social-GAN model is combined with a temporal complementary learning network (TCLNet) for video re-identification, and a video personnel re-identification method based on trajectory fusion in a complex underground space is proposed, so that a problem of large-scale target occlusion in the video personnel re-identification in the complex underground space is solved. Firstly, from a perspective of time domain and space domain, an influence of an external surrounding environment, a personality and hobbies of a pedestrian and other internal factors on a moving direction and a moving speed of a pedestrian trajectory are studied, and the Social-GAN model is used to realize an accurate prediction of the pedestrian trajectory with this social attribute. Then, the proposed spatio-temporal trajectory fusion model is constructed, and predicted pedestrian spatio-temporal trajectory data is sent to the re-identification network to extract apparent visual features, so as to realize an effective combination of the apparent visual features in video sequences and human trajectory data, solve the problem of false extraction of the apparent visual features caused by the occlusion, and effectively alleviate an impact of the occlusion on a re-identification performance.

The video personnel re-identification method based on the trajectory fusion in the complex underground space includes following steps:

S1, establishing a trajectory fusion data set MARS_traj, including personnel identity data and the video sequences; and adding a number of time frames and space coordinate information to each personnel on the MARS_traj, where test sets in the MARS_traj include a retrieval data set query and a candidate data set gallery;

S2, judging whether retrieval videos in the retrieval data set query include occluded images, inputting sequences of the occluded images into the trajectory prediction model for a future trajectory prediction, and obtaining a prediction set query_pred including a predicted trajectory; and going directly to S4, and performing a fusion feature extraction but not the trajectory prediction directly for sequences of images without occlusion in S4;

S3, fusing the obtained query_pred with candidate videos in the candidate data set gallery, and obtaining a new fused video set query_TP; and

S4, extracting spatio-temporal trajectory fusion features including apparent visual information and motion trajectory information by using a video re-identification model for the query_TP, performing a feature distance measure and candidate video ranking, and obtaining final re-identification performance evaluation indexes mAP and Rank-k, where mAP represents a mean average precision, Rank-k indicates a possibility of a cumulative match characteristic (CMC) curve matching correctly in the first k videos in the ranked gallery, and the CMC curve reflects cumulative match characteristics of a retrieval precision of an algorithm; and using a Rank-1 result as a video re-identification result.

In an embodiment, in the S2, the future trajectory prediction is based on a favourable historical trajectory, and is realized by the Social GAN model and belongs to historical trajectory coordinates of known personnel, and predicted trajectory coordinates are obtained.

In an embodiment, in the S3, in the spatio-temporal trajectory fusion features, a temporal trajectory fusion is to calculate a temporal fusion loss lₜ^{tem} in the time domain considering a continuity of the predicted trajectory and the known historical trajectory, as shown in formula (1):

lₜ^{tem}=max[ϕ(Δt−T),0] (1),

where Δt is a frame difference between a last frame of the video sequences in the query and a first frame of video sequences in the gallery, and a frame constant threshold T and a large constant ϕ determine a temporal continuity of the frame difference Δt between the query and the gallery.

In an embodiment, in the S3, in the spatio-temporal trajectory fusion features, a space trajectory fusion is to calculate a space fusion loss lₜ^{spa} considering a dislocation of the predicted trajectory and the frames of the candidate videos in the gallery:

lᵢ^{spa}=min(lⱼ),

∀j∈1,2, . . . ,N,

N=2,3, . . . ,7, (2),

where

$${I}_{j} = \frac{{\sum }_{i = 1}^{n} {p}_{i}}{n} ,$$

(n=9−j), pᵢ represents Euclidean distances between the coordinates corresponding to predicted trajectory sequences and candidate sequences in the gallery; and N represents an allowable deviation range of the predicted trajectory from candidate video frames.

In an embodiment, in the S3, after the temporal fusion loss and the space fusion loss are obtained, a limited fusion loss lᵢ_{ⱼ} in the time domain and the space domain of the jth video in the gallery and the ith video in the query_pred is calculated according to formula (3):

$$\begin{matrix}{l}_{{i}_{j}} = min ( {l}_{j}^{t e m} + {l}_{j}^{s a p} ) , \\ ∀ j ∈ 1 , 2 , … , {N}_{2} ,\end{matrix} , \qquad ( 3 )$$

where N₂ is a total number of video sequences in the gallery, and a minimum/value that minimizes lᵢ_{ⱼ} is obtained according to the formula (3), so that the jth video in the gallery is sent to the query_TP set for a subsequent extraction of the spatio-temporal trajectory fusion features.

In an embodiment, in the S4, a new query set query_TP extracted after the fusion of temporal trajectory and space trajectory and the candidate set gallery are sent to the TCLNet, and finally, group features are aggregated by temporal average pooling to obtain a final fused video feature vector; the TCLNet takes a ResNet-50 network as a backbone network, in which a temporal saliency boosting (TSB) module and a temporal saliency erasing (TSE) module are inserted; and for a T-frame continuous video, the backbone network with the TSB inserted extracts the features from each frame, and the features are labeled as F={F₁, F₂, . . . , F_{T}}, and then the features are equally divided into k groups; each group includes N continuous frame features Cₖ={F_{(k-1)N+1}, . . . , F_{kN}}, and each group is input into the TSE, and the complementary features are extracted by formula (4):

cₖ=TSE(F_{(k-1)N+1}, . . . ,F_{kN})=TSE(Cₖ) (4).

The distance measure between a video feature vector A (x₁,y₁) in the query_TP and the video feature vector B(x₂,y₂) in the candidate set gallery is calculated by a cosine similarity, as shown in formula (5):

$$cos θ = \frac{{x}_{1} {x}_{2} + {y}_{1} {y}_{2}}{\sqrt{{x}_{1}^{2} + {y}_{1}^{2}} \sqrt{{x}_{2}^{2} + {y}_{2}^{2}}} . \qquad ( 5 )$$

The videos in the gallery are ranked according to the distance measure, and the re-identification evaluation indexes mAP and Rank-k are calculated according to a ranking result, and the Rank-1 result is taken as the video re-identification result.

The application has beneficial effects that: the video personnel re-identification method based on the trajectory fusion in the complex underground space is provided, and the problem of large-scale target occlusion of the video personnel re-identification in the complex underground space is solved; the accurate personnel trajectory prediction may be realized through the Social-GAN model; and personnel trajectory videos that are not affected by the occlusion are introduced into the re-identification network to solve the problem of false extraction of the apparent visual features caused by the occlusion and effectively alleviate the impact of the occlusion on the re-identification performance. In addition, the trajectory fusion MARS_traj data set is constructed, and the number of time frames and space coordinate information are added to the MARS data set, so that the trajectory fusion MARS_traj data set is suitable for the video personnel re-identification method based on the trajectory fusion in the complex underground space.

### BRIEF DESCRIPTION OF THE DRAWINGS

FIG. 1 is a flowchart of a video personnel re-identification method based on trajectory fusion in a complex underground space in an embodiment of the application.

FIG. 2 is an illustration of temporal fusion when T=4 in an embodiment of the application.

FIG. 3 is an illustration of space fusion when N=4 in an embodiment of the application.

FIG. 4 is an illustration of sequence tag modification in the MARS_traj data set in an embodiment of the application.

### DETAILED DESCRIPTION OF THE EMBODIMENTS

Technical schemes of the application are further explained in detail with reference to accompanying drawings of the specification.

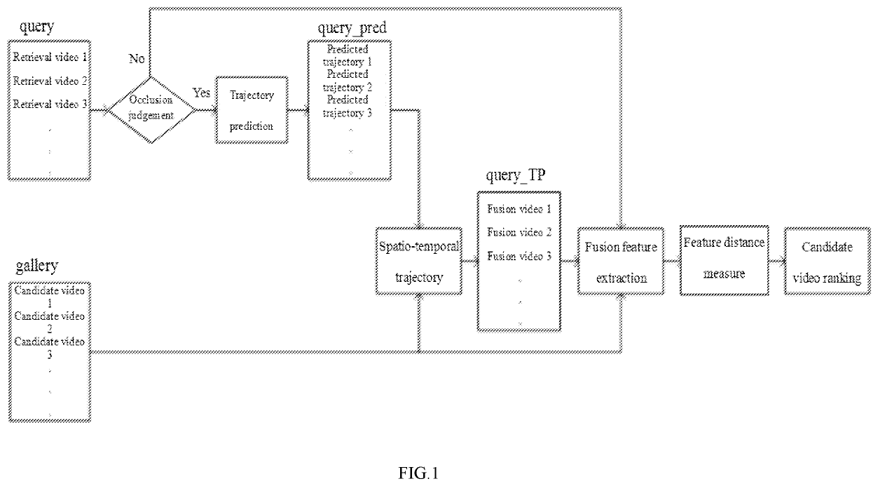

An overall framework of an algorithm according to the application is shown in FIG. 1: firstly, judging whether retrieval videos in a query data set query include occluded images, inputting sequences of the occluded images into a trajectory prediction model for a future trajectory prediction, and performing a fusion feature extraction but not the trajectory prediction directly for sequences of images without occlusion in S4; secondly, fusing an obtained prediction trajectory query_pred data set with candidate videos in gallery in a time domain and a space domain, and obtaining a new fused video sequence query_TP; and finally, extracting spatio-temporal trajectory fusion features including apparent visual information and motion trajectory information by using a video re-identification model, performing a feature distance measure and candidate video ranking, and obtaining final re-identification performance evaluation indexes mAP and Rank-k, where mAP represents a mean average precision, Rank-k indicates a possibility of a cumulative match characteristic (CMC) curve matching correctly in the first k videos in the ranked gallery, and the CMC curve reflects cumulative match characteristics of a retrieval precision of the algorithm; and using a Rank-1 result as a video re-identification result.

A personnel trajectory prediction is to predict a future trajectory of personnel by observing historical trajectory information of the personnel. The application adopts a Social GAN to realize the future trajectory prediction of the personnel. Coordinates of 8 known personnel are input into the Social GAN model for the trajectory prediction, and 8 frames of predicted trajectory coordinates are obtained. From a perspective of time domain and space domain, these predicted trajectory sequences are fused and extracted with the candidate videos in gallery.

(1) Temporal Trajectory Fusion

A temporal fusion loss lₜ^{tem} is calculated in the time domain considering a continuity of the predicted trajectory and the known historical trajectory, as shown in formula (1):

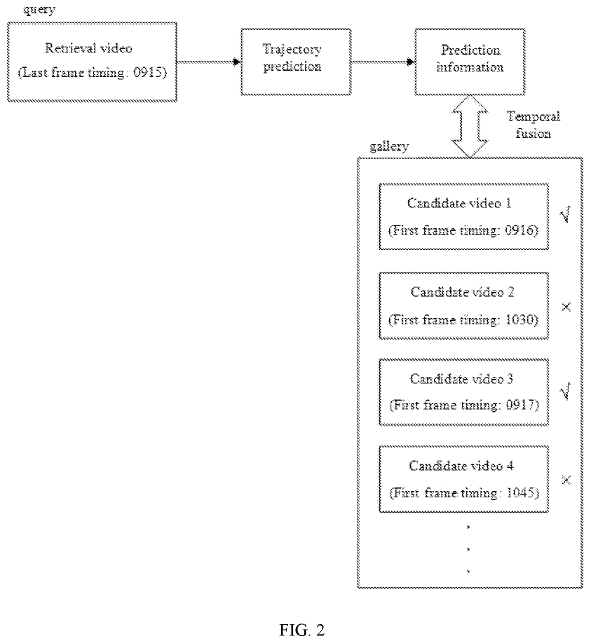

lₜ^{tem}=max[ϕ(Δt−T),0] (1),

where Δt is a frame difference between a last frame of video sequences in the query and a first frame of the video sequences in the gallery, and a frame constant threshold T and a large constant ϕ determine a temporal continuity of the frame difference Δt between the query and the gallery. By comparing values of the frame constant T, T=4 is selected in an embodiment of the application. FIG. 2 shows a selection of the video sequences in the gallery when T=4.

(2) Space Trajectory Fusion

In an actual scene, there are some problems such as discontinuous sequences of the frames between adjacent video sequences, resulting in a dislocation of the frames in the predicted trajectory sequences according to the application and candidate sequences in the gallery. Therefore, according to the application, a space fusion loss lₜ^{spa} is calculated considering a possible frame error:

lᵢ^{spa}=min(lⱼ),

∀j∈1,2, . . . ,N,

N=2,3, . . . ,7, (2),

where

$${I}_{j} = \frac{{\sum }_{i = 1}^{n} {p}_{i}}{n} ,$$

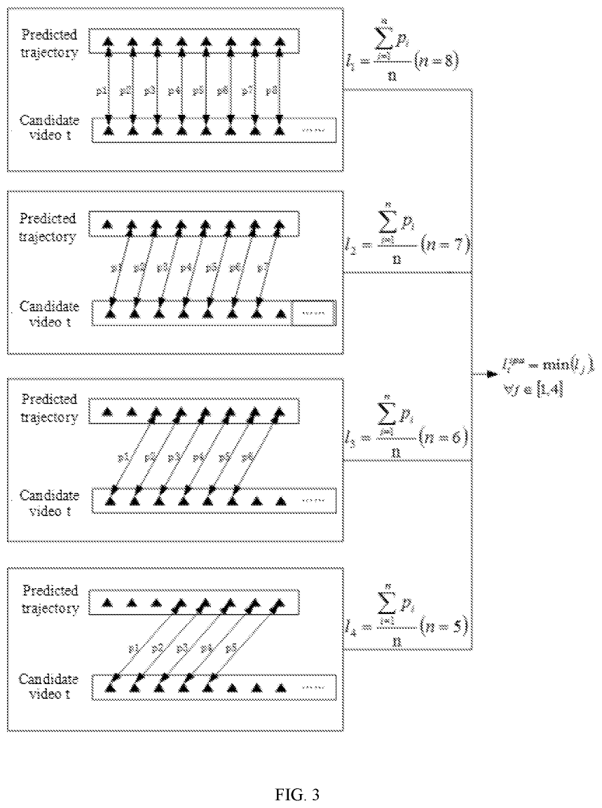

(n=9−j), pᵢ represents Euclidean distances between the coordinates corresponding to the predicted trajectory sequences and the candidate sequences in the gallery, and meanings expressed in different l_{N} are different, as shown in FIG. 3.

In formula (2), N indicates an allowable deviation range between the predicted trajectory sequences and the frames of the candidate videos. Because the frames are fixed, too small N may reduce a flexibility of fusion matching, while too large N may increase a possibility of fusion matching errors. Therefore, when N=4 is adopted in the embodiment of the application, a better experimental result may be obtained.

After the temporal fusion loss and the space fusion loss are obtained according to the formulas (1) and (2), a limited fusion loss lᵢ_{ⱼ} in the time domain and the space domain of the jth video in the gallery and the ith video in the query_pred is calculated according to formula (3):

$$\begin{matrix}{l}_{{i}_{j}} = min ( {l}_{j}^{t e m} + {l}_{j}^{s a p} ) , \\ ∀ j ∈ 1 , 2 , … , {N}_{2} ,\end{matrix} , \qquad ( 3 )$$

where N₂ is a total number of video sequences in the gallery (there is no Min the above formula, please confirm), and a minimum j value that minimizes lᵢ_{ⱼ} (there is no formula 5 in the material, please confirm) is obtained according to the formula (3), so that the jth video sequence in the gallery is sent to the query_TP set for a subsequent extraction of the spatio-temporal trajectory fusion features.

a new query set query_TP extracted after the fusion of temporal trajectory and space trajectory and the candidate set gallery are sent to a temporal complementary learning network (TCLNet). This network takes a ResNet-50 network as a backbone network, in which a temporal saliency boosting (TSB) module and a temporal saliency erasing (TSE) module are inserted. For a T-frame continuous video, the backbone network with the TSB inserted extracts the features from each frame, and the features are labelled as F={F₁, F₂, . . . , F_{T}}, and then the features are equally divided into k groups; each group includes N continuous frame features Cₖ={F_{(k-1)N+1}, . . . , F_{kN}}, and each group is input into the TSE, and complementary features are extracted by formula (4). Finally, group features are aggregated by temporal average pooling to obtain a final fused video feature vector; a distance measure between a video feature vector A(x₁,y₁) in the query_TP and the video feature vector B(x₂,y₂) in the candidate set gallery is calculated by a cosine similarity, as shown in formula (5); and the videos in the gallery are ranked according to the distance measure, and the re-identification evaluation indexes mAP and Rank-k are calculated according to a ranking result, and the Rank-1 result is taken as the video re-identification result.

$${c}_{k} = T S E ( {F}_{( k - 1 ) N + 1} , … , {F}_{k N} ) = T S E ( {C}_{k} ) \qquad ( 4 )$$

$$cos θ = \frac{{x}_{1} {x}_{2} + {y}_{1} {y}_{2}}{\sqrt{{x}_{1}^{2} + {y}_{1}^{2}} \sqrt{{x}_{2}^{2} + {y}_{2}^{2}}} \qquad ( 5 )$$

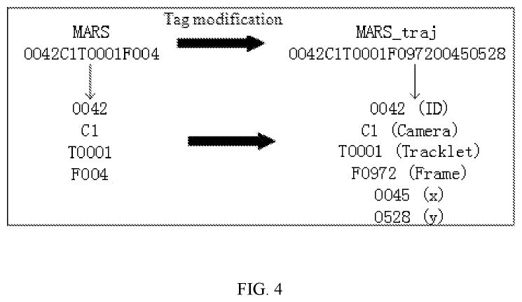

According to the application, a trajectory fusion data set MARS_traj suitable for the personnel re-identification in the occluded videos based on the trajectory prediction is constructed. In order to test an ability of the model to deal with the occlusion problem, test sets of the MARS_traj according the application include a query test set query and a candidate test set gallery, with a total of 744 personnel identities and 9,659 video sequences. In order to verify the personnel trajectory prediction, a number of time frames and space coordinate information are added to a personnel tag for each personnel on the selected MARS_traj test set, as shown in FIG. 4. In order to improve an authenticity of the trajectory, the coordinate values are provided by a real trajectory prediction ETH-UCY data set.

Based on the fusion data set MARS_traj, a flow of the re-identification method according the application is as follows.

Input: data set MARS_traj; trajectory prediction model Social GAN; and video personnel re-identification model.

Output: mAP and rank-k.

(1) Spatio-temporal information in a video ID in the query data set is input into the trajectory prediction model.

(2) A generator in the Social GAN generates a possible prediction trajectory according to the input spatio-temporal information.

(3) A discriminator in the Social GAN discriminates the generated prediction trajectory to obtain the query_pred accorded with the prediction trajectory.

(4) An initial value is set to i=1.

(5) The initial value is set to j=1.

(6) The temporal fusion loss and the space fusion loss of the jth video in the gallery and the ith video prediction trajectory predi in the query_pred are calculated according to the formula (1) and formula (2).

(7)j=j+1; the operation (6) is repeated until j=N₂ (the number of video sequences in the gallery of the MARS_traj data set).

(8) A minimum limited fusion loss is obtained according to the formula (3), and j corresponding to the minimum limited fusion loss is assigned iⱼ.

(9) The ith video sequence in the Gallery is put into query_TP.

(10) i=i+1; the operations (5)-(9) are repeated until i=N₁ (the number of video sequences in the query of the MARS_traj data set).

(11) Video fusion features of the query_TP and the gallery are extracted.

(12) The feature distance measure is calculated according to the video features in the query_TP and the gallery, and the gallery is ranked.

(13) The final re-identification performance evaluation indexes mAP and Rank-k are obtained according to the query, and the Rank-1 result is used as the video re-identification result. mAP represents the mean average precision, Rank-k indicates the possibility of the cumulative match characteristic (CMC) curve matching correctly in the first k videos in the ranked gallery, and the CMC curve reflects the cumulative match characteristics of the retrieval precision of the algorithm.

The above are only the preferred embodiments of the application, and a scope of protection of the application is not limited to the above embodiments. However, all equivalent modifications or changes made by ordinary technicians in the field according to the disclosure of the application should be included in the scope of protection stated in claims.

What is claimed is:

1. A video personnel re-identification method based on trajectory fusion in a complex underground space, comprising following steps:
S1, establishing a trajectory fusion data set MARS_traj, comprising personnel identity data and video sequences; and adding a number of time frames and space coordinate information to each person on the MARS_traj, wherein test sets in the MARS_traj comprise a retrieval data set query and a candidate data set gallery;
S2, judging whether retrieval videos in the retrieval data set query comprise occluded images, inputting sequences of the occluded images into a trajectory prediction model for a future trajectory prediction, and obtaining a prediction set query_pred comprising a predicted trajectory; and going to S4, and performing a fusion feature extraction but not the trajectory prediction directly for sequences of images without occlusion in the S4;
S3, fusing the obtained query_pred with candidate videos in the candidate data set gallery, and obtaining a new fused video set query_TP; and
S4, extracting spatio-temporal trajectory fusion features comprising apparent visual information and motion trajectory information by using a video re-identification model for the query_TP, performing a feature distance measure and candidate video ranking, and obtaining final re-identification performance evaluation indexes mAP and Rank-k, wherein mAP represents a mean average precision, Rank-k indicates a possibility of a cumulative match characteristic (CMC) curve matching correctly in the first k videos in the ranked gallery, and the CMC curve reflects cumulative match characteristics of a retrieval precision of an algorithm; and using a Rank-1 result as a video re-identification result.

2. The video personnel re-identification method based on the trajectory fusion in the complex underground space according to claim 1, wherein in the S2, the future trajectory prediction is based on a favourable historical trajectory, and is realized by a Social GAN model and belongs to historical trajectory coordinates of known personnel, and predicted trajectory coordinates are obtained.

3. The video personnel re-identification method based on the trajectory fusion in the complex underground space according to claim 1, wherein in the S3, in the spatio-temporal trajectory fusion features, a temporal trajectory fusion is to calculate a temporal fusion loss lₜ^{tem} in a time domain considering a continuity of the predicted trajectory and the known historical trajectory, as shown in formula (1):
lₜ^{tem}=max[ϕ(Δt−T),0] (1),
wherein Δt is a frame difference between a last frame of the video sequences in the query and a first frame of video sequences in the gallery, and a frame constant threshold T and a large constant ϕ determine a temporal continuity of the frame difference Δt between the query and the gallery.

4. The video personnel re-identification method based on the trajectory fusion in the complex underground space according to claim 1, wherein in the S3, in the spatio-temporal trajectory fusion features, a space trajectory fusion is to calculate a space fusion loss lₜ^{spa} considering a dislocation of the predicted trajectory and the frames of the candidate videos in the gallery:
lᵢ^{spa}=min(lⱼ),
∀j∈1,2, . . . ,N,
N=2,3, . . . ,7, (2),
wherein
$${I}_{j} = \frac{{\sum }_{i = 1}^{n} {p}_{i}}{n} ,$$
(n=9−j), pᵢ represents Euclidean distances between the coordinates corresponding to predicted trajectory sequences and candidate sequences in the gallery; and N represents an allowable deviation range of the predicted trajectory from candidate video frames.

5. The video personnel re-identification method based on the trajectory fusion in the complex underground space according to claim 1, wherein in the S3, after the temporal fusion loss and the space fusion loss are obtained, a limited fusion loss lᵢ_{ⱼ} in the time domain and a space domain of the jth video in the gallery and the ith video in the query_pred is calculated according to formula (3):
$$\begin{matrix}{l}_{{i}_{j}} = min ( {l}_{j}^{t e m} + {l}_{j}^{s a p} ) , \\ ∀ j ∈ 1 , 2 , … , {N}_{2} ,\end{matrix} , \qquad ( 3 )$$
where in N₂ is a total number of video sequences in the gallery, and a minimum j value that minimizes lᵢ_{ⱼ} is obtained according to the formula (3), so that the jth video in the gallery is sent to the query_TP set for a subsequent extraction of the spatio-temporal trajectory fusion features.

6. The video personnel re-identification method based on the trajectory fusion in the complex underground space according to claim 1, wherein in the S4, a new query set query_TP extracted after the fusion of temporal trajectory and space trajectory and the candidate set gallery are sent to a temporal complementary learning network (TCLNet), and finally, group features are aggregated by temporal average pooling to obtain a final fused video feature vector; the TCLNet takes a ResNet-50 network as a backbone network, wherein a temporal saliency boosting (TSB) module and a temporal saliency erasing (TSE) module are inserted; and for a T-frame continuous video, the backbone network with the TSB inserted extracts the features from each frame, and the features are labelled as F={F₁, F₂, . . . , F_{T}}, and then the features are equally divided into k groups; each group comprises N continuous frame features Cₖ={F_{(k-1)N+1}, . . . , F_{kN}}, and each group is input into the TSE, and complementary features are extracted by formula (4):
cₖ=TSE(F_{(k-1)N+1}, . . . ,F_{kN})=TSE(Cₖ) (4);
the distance measure between a video feature vector A (x₁,y₁) in the query_TP and the video feature vector B (x₂,y₂) in the candidate set gallery is calculated by a cosine similarity, as shown in formula (5):
$$cos θ = \frac{{x}_{1} {x}_{2} + {y}_{1} {y}_{2}}{\sqrt{{x}_{1}^{2} + {y}_{1}^{2}} \sqrt{{x}_{2}^{2} + {y}_{2}^{2}}} ; \qquad ( 5 )$$
and
the videos in the gallery are ranked according to the distance measure, and the re-identification evaluation indexes mAP and Rank-k are calculated according to a ranking result, and the Rank-1 result is taken as the video re-identification result.
